(19) United States
(12) Patent Application Publication
(10) Pub. No.: US 2016/0129676 A1
(43) Pub. Date: May 12, 2016

(54) FIBER-REINFORCED PLASTIC, AIR RECTIFICATION COVER FOR ELEVATOR AND PROCESS FOR MANUFACTURING FIBER-REINFORCED PLASTIC

(71) Applicant: MITSUBISHI ELECTRIC CORPORATION, Tokyo (JP)

(72) Inventors: Sohei SAMEJIMA, Chiyoda-ku (JP); Hiroki KOBAYASHI, Chiyoda-ku (JP); Hajime TAKEYA, Chiyoda-ku (JP)

(73) Assignee: MITSUBISHI ELECTRIC CORPORATION, Tokyo (JP)

(21) Appl. No.: 14/894,701

(22) PCT Filed: Jun. 4, 2014
(86) PCT No.: PCT/JP14/64860

§ 371 Date: Nov. 30, 2015

(30) Foreign Application Priority Data
Jun. 21, 2013 (JP) 2013-130919

(51) Int. Cl. B32B 27/12; B32B 27/08; B66B 11/02; B29C 70/48; B29C 70/44; B29C 70/54; B32B 5/02; B32B 27/20

(52) U.S. Cl. CPC B32B 27/12; B32B 5/024; B32B 27/08; B32B 27/20; B29C 70/48; B29C 70/443; B29C 70/547; B66B 11/0226; B32B 2260/046; B32B 2264/102; B32B 2307/724; B32B 2571/00; B29K 2033/04

(57) ABSTRACT

A fiber reinforced plastic including: a first fiber reinforced plastic layer including a first fiber fabric and a resin impregnated into the first fiber fabric; a resin flow layer including an inner medium and a resin, the resin flow layer being laminated on the first fiber reinforced plastic layer; a second fiber reinforced plastic layer including a second fiber fabric and a resin impregnated into the second fiber fabric, the second fiber reinforced plastic layer being laminated on the resin flow layer so that the resin flow layer is arranged between the first fiber reinforced plastic layer and the second fiber reinforced plastic layer; and an inorganic filler layer including an inorganic filler having a particle diameter of 20 μm or more and 50 μm or less and a resin, the inorganic filler layer being laminated on the second fiber reinforced plastic layer.

### TECHNICAL FIELD

The present invention relates to a fiber reinforced plastic having a fiber fabric impregnated with a resin, an air-regulating cover for an elevator formed of a fiber reinforced plastic, and a method of producing a fiber reinforced plastic.

### BACKGROUND ART

As a light-weight and high-strength material, fiber reinforced plastics (FRPs) are drawing attention in various industrial fields. In recent years, as a method of producing a fiber reinforced plastic compact having a relatively large size, such as a blade of a wind mill, an aircraft part, or a ship, at low cost, a production method called vacuum assist resin transfer molding (VaRTM) has been widely used. The vacuum assist resin transfer molding has, for example, the following features: a large-scale facility such as an autoclave (pressure vessel) is not required; a large structure is integrally molded easily; and an organic solvent is unlikely to be volatilized, which is advantageous for working environment.

Hitherto, a method of producing a fiber reinforced plastic has been known, which includes: a fiber fabric-inner medium lamination step of alternately laminating, on a mold, a plurality of fiber fabrics and a plurality of inner media so that the inner media are arranged between the fiber fabrics; a peel ply lamination step of laminating a peel ply on the fiber fabric in an uppermost layer; a flow medium lamination step of laminating a flow medium on the peel ply; amounting step including mounting an air suction port of a vacuum pump and a resin injection port of a resin tank to the mold, covering the whole with a bagging film, and bonding a periphery of the bagging film to the mold with a sealant; and a vacuum impregnation step including bringing an inside of the bagging film into a vacuum state through suction of air with the vacuum pump, and then injecting a resin into the bagging film from the resin tank (see, for example, Patent Literature 1).

### CITATION LIST

### Patent Literature

[PTL 1] JP 2009-248552 A

### SUMMARY OF INVENTION

### Technical Problem

However, according to the above-mentioned method, when one intended fiber reinforced plastic is produced, a set of the peel ply, the flow medium, and the bagging film each having a predetermined area is required and discarded after the resin is cured. Therefore, there is a problem of poor production efficiency. Further, it is difficult to form the peel ply, the flow medium, and the bagging film each having a planar shape into a curved shape, and as a result, there is a problem in that the production efficiency of the fiber reinforced plastic is poor.

According to embodiments of the present invention, there are provided a fiber reinforced plastic capable of being improved in production efficiency and a production method therefor.

### Solution to Problem

According to one embodiment of the present invention, there is provided a fiber reinforced plastic, including: a first fiber reinforced plastic layer including a first fiber fabric and a resin for a first fiber fabric impregnated into the first fiber fabric; a resin flow layer including a resin diffusion medium and a resin for a resin diffusion medium, the resin flow layer being laminated on the first fiber reinforced plastic layer; a second fiber reinforced plastic layer including a second fiber fabric and a resin for a second fiber fabric impregnated into the second fiber fabric, the second fiber reinforced plastic layer being laminated on the resin flow layer so that the resin flow layer is arranged between the first fiber reinforced plastic layer and the second fiber reinforced plastic layer; and an inorganic filler layer including an inorganic filler having a particle diameter of 20 μm or more and 50 μm or less and a resin for an inorganic filler, the inorganic filler layer being laminated on the second fiber reinforced plastic layer so that the second fiber reinforced plastic layer is arranged between the resin flow layer and the inorganic filler layer, in which the resin for a first fiber fabric, the resin for a resin diffusion medium, the resin for a second fiber fabric, and the resin for an inorganic filler each have the same composition and are formed so as to be integrated with each other.

### Advantageous Effects of Invention

The fiber reinforced plastic according to the embodiment of the present invention includes: the first fiber reinforced plastic layer including the first fiber fabric and the resin for a first fiber fabric impregnated into the first fiber fabric; the resin flow layer including the resin diffusion medium and the resin for a resin diffusion medium, the resin flow layer being laminated on the first fiber reinforced plastic layer; the second fiber reinforced plastic layer including the second fiber fabric and the resin for a second fiber fabric impregnated into the second fiber fabric, the second fiber reinforced plastic layer being laminated on the resin flow layer so that the resin flow layer is arranged between the first fiber reinforced plastic layer and the second fiber reinforced plastic layer; and the inorganic filler layer including the inorganic filler having a particle diameter of 20 μm or more and 50 μm or less and the resin for an inorganic filler, the inorganic filler layer being laminated on the second fiber reinforced plastic layer so that the second fiber reinforced plastic layer is arranged between the resin flow layer and the inorganic filler layer, in which the resin for a first fiber fabric, the resin for a resin diffusion medium, the resin for a second fiber fabric, and the resin for an inorganic filler each have the same composition and are formed so as to be integrated with each other. Therefore, when an intended fiber reinforced plastic is molded, the peel ply, the flow medium, and the bagging film are not required. As a result, the production efficiency of the fiber reinforced plastic can be enhanced.

### BRIEF DESCRIPTION OF DRAWINGS

FIG. 1 is a sectional view for illustrating a fiber reinforced plastic according to a first embodiment of the present invention.

FIG. 2 is an enlarged view for illustrating a first fiber reinforced plastic layer of FIG. 1.

FIG. 3 is an enlarged view for illustrating a resin flow layer of FIG. 1.

FIG. 4 is an enlarged view for illustrating an inorganic filler layer of FIG. 1.

FIG. 5 is an enlarged view for illustrating a second fiber reinforced plastic layer and an inorganic filler layer of FIG. 1.

FIG. 6 is a schematic view for illustrating a forming step in a method of producing a fiber reinforced plastic of FIG. 1.

FIG. 7 is a schematic view for illustrating an adhesion step in the method of producing a fiber reinforced plastic of FIG. 1.

FIG. 8 is a schematic view for illustrating a bagging step in the method of producing a fiber reinforced plastic of FIG. 1.

FIG. 9 is a schematic view for illustrating a resin impregnation step in the method of producing a fiber reinforced plastic of FIG. 1.

FIG. 10 is a schematic view for illustrating a demolding step and a removal step in the process of producing a fiber reinforced plastic of FIG. 1.

FIG. 11 is a sectional view for illustrating a modified example of the fiber reinforced plastic according to the first embodiment of the present invention.

FIG. 12 is a perspective view for illustrating an air-regulating cover for an elevator according to a second embodiment of the present invention.

### DESCRIPTION OF EMBODIMENTS

### First Embodiment

FIG. 1 is a sectional view for illustrating a fiber reinforced plastic according to a first embodiment of the present invention. In FIG. 1, a fiber reinforced plastic 1 includes a first fiber reinforced plastic layer 2, a resin flow layer 3, a second fiber reinforced plastic layer 4, and an inorganic filler layer 5. The resin flow layer 3 is laminated on the first fiber reinforced plastic layer 2. The second fiber reinforced plastic layer 4 is laminated on the resin flow layer 3 so that the resin flow layer 3 is arranged between the first fiber reinforced plastic layer 2 and the second fiber reinforced plastic layer 4. The inorganic filler layer 5 is laminated on the second fiber reinforced plastic layer 4 so that the second fiber reinforced plastic layer 4 is arranged between the resin flow layer 3 and the inorganic filler layer 5. In other words, the first fiber reinforced plastic layer 2, the resin flow layer 3, the second fiber reinforced plastic layer 4, and the inorganic filler layer 5 are laminated in the stated order.

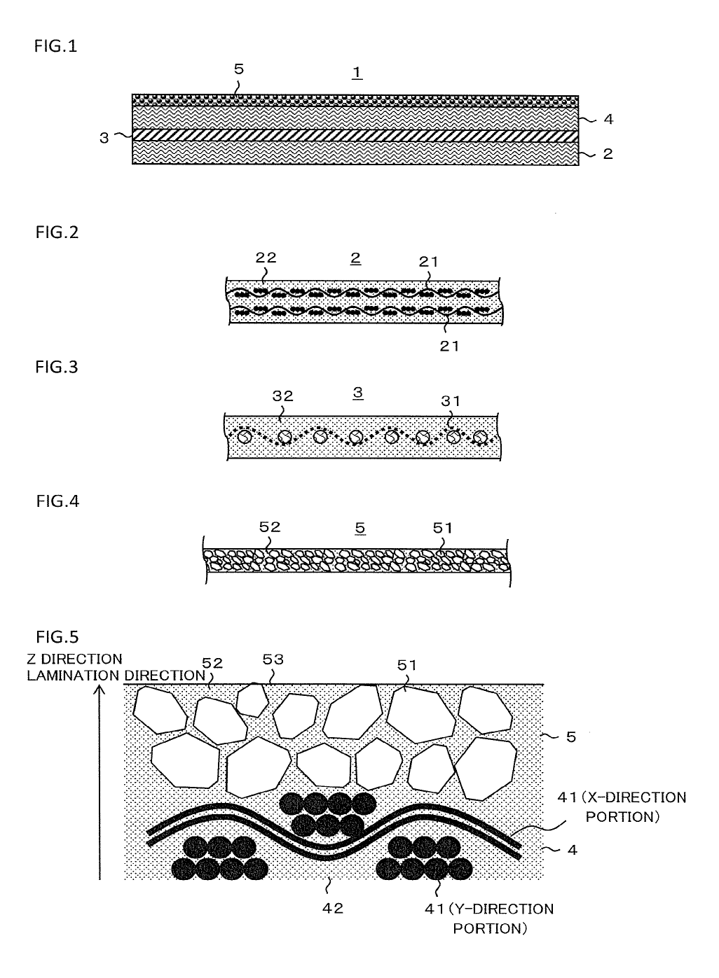

FIG. 2 is an enlarged view for illustrating the first fiber reinforced plastic layer 2 of FIG. 1. The first fiber reinforced plastic layer 2 includes a first fiber fabric 21 and a resin (resin for a first fiber fabric) 22 impregnated into the first fiber fabric 21. As the first fiber fabric 21, for example, there are given fabrics made of carbon fibers, glass fibers, xyron fibers, Kevlar fibers, or the like. In this example, carbon fibers each having a fiber diameter of 7 μm are used. The second fiber reinforced plastic layer 4 has the same configuration as that of the first fiber reinforced plastic layer 2 and includes a second fiber fabric 41 and a resin (resin for a second fiber fabric) 42 impregnated into the second fiber fabric 41.

FIG. 3 is an enlarged view for illustrating the resin flow layer 3 of FIG. 1. The resin flow layer 3 includes an inner medium (resin diffusion medium) 31 and a resin (resin for a resin diffusion medium) 32 entering the inner medium 31. A flow medium is an auxiliary material for diffusing the resin and is removed and discarded from the fiber reinforced plastic 1. Therefore, there is no particular limitation on the material. In contrast, the inner medium similarly serves to diffuse the resin and remains to function as a reinforcing base in a product. Therefore, there is no particular limitation on the inner medium 31 as long as the inner medium 31 has a small flow resistance, and the inner medium 31 formed of glass fibers or carbon fibers, which are reinforcing fibers, is more desired than the inner medium 31 formed of a thermoplastic resin such as nylon.

FIG. 4 is an enlarged view for illustrating the inorganic filler layer 5 of FIG. 1. The inorganic filler layer 5 includes a plurality of inorganic fillers 51 and a resin (resin for an inorganic filler) 52 in which the inorganic fillers 51 is penetrated. There is no particular limitation on the inorganic filler 51, and from the viewpoint of flame retardancy, aluminum hydroxide, antimony trioxide, a mixture thereof, or the like is more desired than calcium carbonate, silicon dioxide, aluminum oxide, or the like.

It is desired that the average particle diameter of the inorganic filler 51 be larger than the fiber diameter of the second fiber fabric 41. In the case where the particle diameter of the inorganic filler 51 is smaller than the fiber diameter of the second fiber fabric 41, a silicone bag 62 (FIG. 8) described later is brought into contact with the second fiber fabric 41. In general, the fiber diameter of the second fiber fabric 41 is 10 μm or less. Therefore, it is desired that the average particle diameter of the inorganic filler 51 be 20 μm or more, which is twice the fiber diameter of the second fiber fabric 41.

Further, it is desired that the average particle diameter of the inorganic filler 51 be 50 μm or less. In the case where the particle diameter of the inorganic filler 51 is more than 50 μm, the inorganic filler 51 comes off from the silicone bag 62 (FIG. 7) due to the own weight of the inorganic filler 51, and as a result, portions of the silicone bag 62, which are brought into contact with the second fiber fabric 41, increase.

In this example, as the inorganic filler 51, aluminum hydroxide having an average particle diameter of 27 μm is used.

The resin 22, the resin 32, the resin 42, and the resin 52 each have the same composition and are formed so as to be integrated with each other. The resin 22, the resin 32, the resin 42, and the resin 52 are not particularly limited as long as the resin 22, the resin 32, the resin 42, and the resin 52 are resins each having a low viscosity such as an epoxy resin, a polyester resin, and a vinyl ester resin, and a vinyl ester resin capable of being cured at normal temperature is desired.

FIG. 5 is an enlarged view for illustrating the second fiber reinforced plastic layer 4 and the inorganic filler layer 5 of FIG. 1. The second fiber fabric 41 is covered with the inorganic filler layer 5 and is not exposed. The inorganic filler 51 does not project from a surface 53 of the resin 52 on an opposite side to the second fiber reinforced plastic layer 4 side.

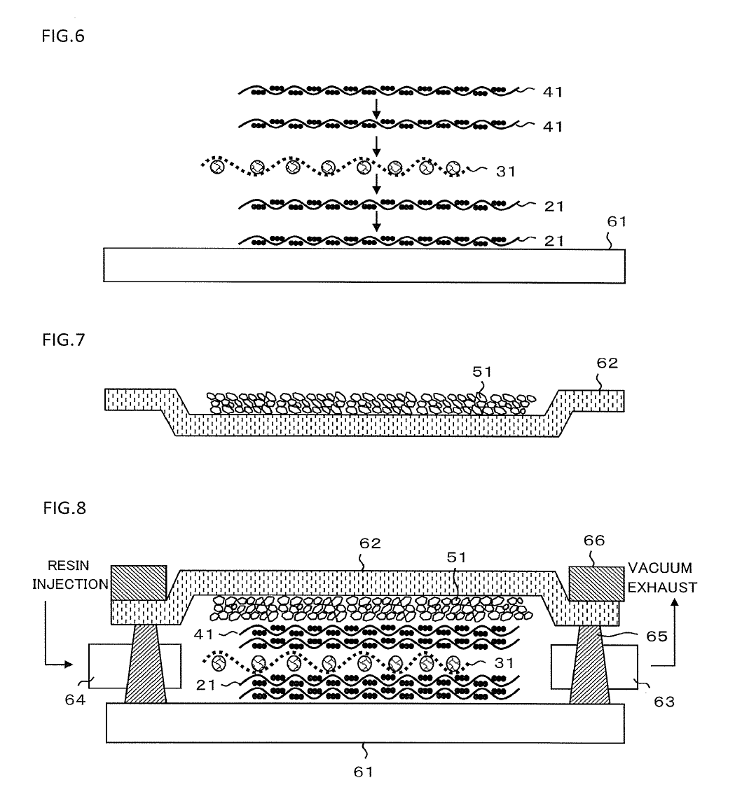

In the case where a plurality of fiber reinforced plastics 1 are produced, after the mold is produced, the step of producing the silicone bag 62 is performed once, and the step of molding the fiber reinforced plastic 1 is repeated a predetermined number of times. Each of the configurations is described. First, a method of producing the fiber reinforced plastic 1 is described. FIG. 6 is a schematic view for illustrating a forming step in the method of producing the fiber reinforced plastic 1 of FIG. 1. First, two first fiber fabrics 21 are laminated on a mold (made of aluminum, thickness: 3 mm) 61 subjected to Teflon (trademark) coating so as to have releasability. The lamination direction corresponds to the thickness direction of the fiber reinforced plastic 1. Next, the inner medium 31 is laminated on the first fiber fabric 21. Then, two second fiber fabrics 41 are laminated on the inner medium 31. Thus, the forming step is completed.

FIG. 7 is a schematic view for illustrating an adhesion step in the method of producing the fiber reinforced plastic 1 of FIG. 1. After the forming step, the inorganic filler 51 is caused to adhere to the silicone bag 62 formed into a predetermined shape. Specifically, first, the inorganic filler 51 is caused to adhere to sponge (not shown), and the inorganic filler 51 is transferred onto the silicone bag 62 from the sponge (adhesion step). The silicone bag 62 has a curved surface, but silicone forming the silicone bag 62 has a property of causing foreign substances (such as dust) to adsorb thereto. Therefore, the silicone bag 62 can cause the inorganic filler 51 to adhere thereto moderately and easily without using an adhesive, a binder, or the like. It should be noted that the inorganic filler layer 5 may be laminated on both the first fiber reinforced plastic layer 2 and the second fiber reinforced plastic layer 4 by causing the inorganic filler 51 to adhere to the mold 61 (FIG. 6).

FIG. 8 is a schematic view for illustrating a bagging step in the method of producing the fiber reinforced plastic 1 of FIG. 1. After the adhesion step, an air suction port 63 of a vacuum pump and a resin injection port 64 of a resin tank are mounted to the mold 61, and the silicone bag 62 and the mold 61 cover the first fiber fabric 21, the inner medium 31, and the second fiber fabric 41 so that the inorganic filler 51 faces the second fiber fabric 41. Next, a periphery of the silicone bag 62 is brought into close contact with the mold 61 so that air does not leak from between the mold 61 and the silicone bag 62 (bagging step). As a method of bringing the silicone bag 62 into close contact with the mold 61, a pressure-sensitive adhesive called a sealant is generally used. However, silicone forming the silicone bag 62 has releasability, and hence it is difficult to form a vacuum between the mold 61 and the silicone bag 62 through use of the sealant. Therefore, it is desired that a dam material 65 made of silicone having an O-ring shape be bonded to the mold 61 through use of a silicone adhesive, and the close contact be obtained between the silicone bag 62 and the dam material 65 through use of a frame 66.

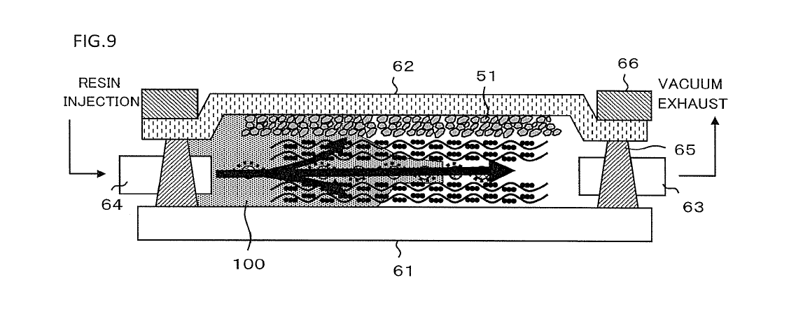

FIG. 9 is a schematic view for illustrating a resin impregnation step in the method of producing the fiber reinforced plastic 1 of FIG. 1. After the bagging step, the vacuum pump is driven to bring a sealed space between the mold 61 and the silicone bag 62 into a vacuum state. Then, a resin 100 (resin 22, resin 32, resin 42, and resin 52) is injected into the sealed space between the mold 61 and the silicon bag 62 from the resin tank. The sealed space between the mold 61 and the silicone bag 62 is in a vacuum state. Therefore, the resin 100 spreads to the entire surface of the inner medium 31 having a relatively small flow passage resistance and then enters in the thickness direction of the first fiber fabric 21 and the second fiber fabric 41, that is, the lamination direction, with the result that the first fiber fabric 21 and the second fiber fabric 41 are impregnated with the resin 100 (resin impregnation step). In this case, when the inner medium 31 having a coarse texture is connected from the resin injection port 64 to the air suction port 63, the resin 100 does not permeate the first fiber fabric 21 and the second fiber fabric 41 which are finely-woven and have a high flow resistance. Therefore, it is necessary to cut the inner medium 31 in the vicinity of the air suction port 63.

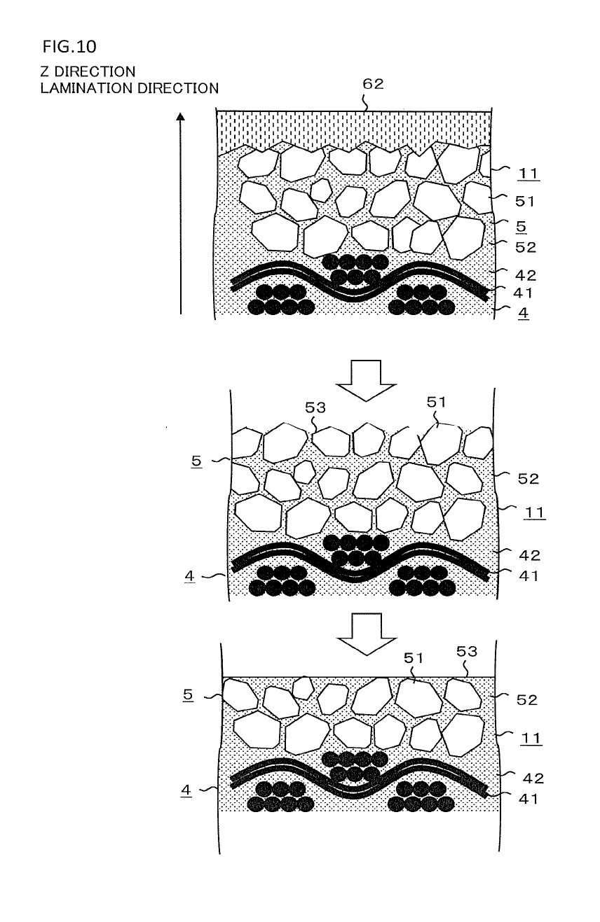

FIG. 10 is a schematic view for illustrating a demolding step and a removal step in the process of producing the fiber reinforced plastic 1 of FIG. 1. After the resin impregnation step, the injection of the resin 100 from the resin tank is stopped, and the resin 100 is cured by being left to stand for 1 day to form a fiber reinforced plastic body 11 (curing step). Then, the silicone bag 62 is taken out from the mold 61, and further the fiber reinforced plastic body 11 is taken out from the mold 61 (demolding step). After that, portions, in which the inorganic filler 51 projects, of the surface 53 (bag surface of the fiber reinforced plastic body 11 facing the silicone bag 62) of the inorganic filler layer 5 are removed by polishing (removal step). In the removal step, sandpaper can be used. The resin 52 does not adhere to the portions, in which the inorganic filler 51 projects, of the inorganic filler layer 5, and hence it is necessary to remove the projecting portions. When the projecting portions of the inorganic filler 51 are removed, the fiber reinforced plastic 1 is formed. Further, the entire body or the surface of the silicone bag 62 is formed of a silicone resin excellent in releasability, and hence the silicone bag 62 can be re-used in molding the fiber reinforced plastic 1 a plurality of times.

Next, a method of producing the silicone bag 62 is described. First, two first fiber fabrics 21 are laminated on the mold 61 subjected to Teflon coating so as to have releasability. After that, the inner medium 31 is laminated on the first fiber fabric 21. Then, two second fiber fabrics 41 are laminated on the inner medium 31.

Next, a peel fly and a bagging film are laminated on the second fiber fabric 41, and the air suction port 63 and the resin injection port 64 are mounted to the mold 61. Further, the bagging film is bonded to the mold 61 through use of a sealant.

After that, 100 parts by weight of an unsaturated polyester resin, 0.5 part by weight of a curing agent, and 0.5 part by weight of a curing accelerator are mixed, and the mixture is defoamed to produce a resin for impregnation.

Then, the vacuum pump is driven to bring a sealed space between the bagging film and the mold 61 into a vacuum state, and a resin is injected into the sealed space between the bagging film and the mold 61 through the resin injection port 64, with the result that the first fiber fabric 21 and the second fiber fabric 41 are impregnated with the resin.

After the impregnation step, the injection of the resin is stopped, and the resin is cured by being left to stand for 1 day at room temperature.

Then, the peel ply and the bagging film are taken out from the mold 61, and further, the fiber reinforced plastic body 11 is taken out from the mold 61. The fiber reinforced plastic body 11 is trimmed to form a dummy material for obtaining the silicone bag 62.

Next, a two-component RTV rubber is mixed and defoamed. Then, the dummy material is fixed onto the mold 61. The two-component RTV rubber in a liquid form is dropped onto the dummy material and cured by being left to stand for 1 day. With this, the silicone bag 62 offset by the thickness of the dummy material is produced.

As described above, the fiber reinforced plastic 1 according to the first embodiment of the present invention includes: the first fiber reinforced plastic layer 2 including the first fiber fabric 21 and the resin 22 impregnated into the first fiber fabric 21; the resin flow layer 3 including the inner medium 31 and the resin 32, the resin flow layer 3 being laminated on the first fiber reinforced plastic layer 2; the second fiber reinforced plastic layer 4 including the second fiber fabric 41 and the resin 42 impregnated into the second fiber fabric 41, the second fiber reinforced plastic layer 4 being laminated on the resin flow layer 3 so that the resin flow layer 3 is arranged between the first fiber reinforced plastic layer 2 and the second fiber reinforced plastic layer 4; and the inorganic filler layer 5 including the inorganic filler 51 having a particle diameter of 20 μm or more and 50 μm or less and the resin 52, the inorganic filler layer 5 being laminated on the second fiber reinforced plastic layer 4 so that the second fiber reinforced plastic layer 4 is arranged between the resin flow layer 3 and the inorganic filler layer 5, in which the resin 22, the resin 32, the resin 42, and the resin 52 each have the same composition and are formed so as to be integrated with each other. Therefore, when an intended fiber reinforced plastic is molded, the peel ply, the flow medium, and the bagging film are not required. As a result, the production efficiency of the fiber reinforced plastic 1 can be enhanced.

Further, the inorganic filler 51 has a particle diameter of 20 μm or more and 50 μm or less. Therefore, the silicone bag 62 can be prevented from being brought into contact with the second fiber fabric 41, and the inorganic filler 51 can be prevented from coming off from the silicone bag 62 due to the own weight of the inorganic filler 51.

Further, the inorganic filler 51 is aluminum hydroxide, antimony trioxide, or a mixture thereof, and hence the inorganic filler 51 can made flame retardant.

Further, the method of producing the fiber reinforced plastic 1 according to the first embodiment of the present invention includes: the forming step including laminating the first fiber fabric 21 on the mold 61, laminating the inner medium 31 on the first fiber fabric 21, and laminating the second fiber fabric 41 on the inner medium 31; the adhesion step of causing the inorganic filler 51 to adhere to the silicone bag 62; the bagging step of covering the first fiber fabric 21, the inner medium 31, and the second fiber fabric 41 with the silicone bag 62 and the mold 61 so that the inorganic filler 51 faces the second fiber fabric 41; the impregnation step of impregnating the first fiber fabric 21 and the second fiber fabric 41 with the liquid resin 100 through use of the inner medium 31 as a resin flow passage; the curing step of curing the resin 100 after the impregnation step; the demolding step of taking out, after the curing step, the fiber reinforced plastic body 11 formed integrally with the resins 22, 32, 42, and 52 from the mold 61 and the silicone bag 62; and the removal step of removing by polishing, after the remolding step, the portion, in which the inorganic filler 51 projects, of the surface 53 of the fiber reinforced plastic body 11 facing the silicone bag 62. Therefore, when the fiber reinforced plastic 1 is produced, the peel ply, the flow medium, and the bagging film are not required. As a result, the production efficiency of the fiber reinforced plastic 1 can be enhanced. Further, the inorganic filler 51 exists between the second fiber fabric 41 and the silicone bag 62. Therefore, the close contact between the second fiber fabric 41 and the silicone bag 62 can be prevented, and the entire region of the second fiber fabric 41 can be impregnated with the resin 42. Further, the portions, in which the inorganic filler 51 projects, of the surface 53 of the fiber reinforced plastic body 11 facing the silicone bag 62 are removed by polishing, and hence the damage to the second fiber fabric 41 can be prevented.

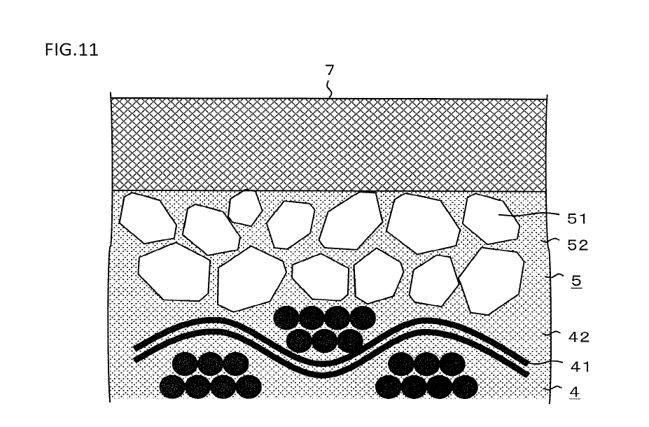

It should be noted that, in the first embodiment, the configuration of the fiber reinforced plastic 1 in which the inorganic filler layer 5 is exposed has been described. However, as illustrated in FIG. 11, the fiber reinforced plastic 1 may have a configuration of further including a coating 7 formed on the surface 53 of the inorganic filler layer 5. As the coating 7, a urethane resin or the like can be used. In the case where carbon fibers are used as the fiber fabric 41, the in-plane coefficient of thermal expansion of the second fiber reinforced plastic layer 4 is about 0 ppm/K, whereas the in-plane coefficient of thermal expansion of the coating 7 is about 60 ppm/K. Therefore, there is a problem in that, when a heat cycle test is conducted, cracks are liable to occur in the coating 7 due to the difference in coefficient of thermal expansion. However, the fiber reinforced plastic 1 includes the inorganic filler layer 5 having an in-plane coefficient of thermal expansion of 30 ppm/K between the coating 7 and the second fiber reinforced plastic layer 4, and hence the crack resistance of the coating 7 can be enhanced. Further, the inorganic filler layer 5 serves as an underlying layer of the coating 7, and hence the exposure of the second fiber fabric 41 can be suppressed in the case of the occurrence of the damage to the coating 7. The applicant of the present application conducted a heat cycle test (−40° C. to +85° C., 500 cyc) with respect to the fiber reinforced plastic 1 having the coating 7 of 30 μm, and as a result, satisfactory results were obtained without the occurrence of cracks in the coating 7.

### Second Embodiment

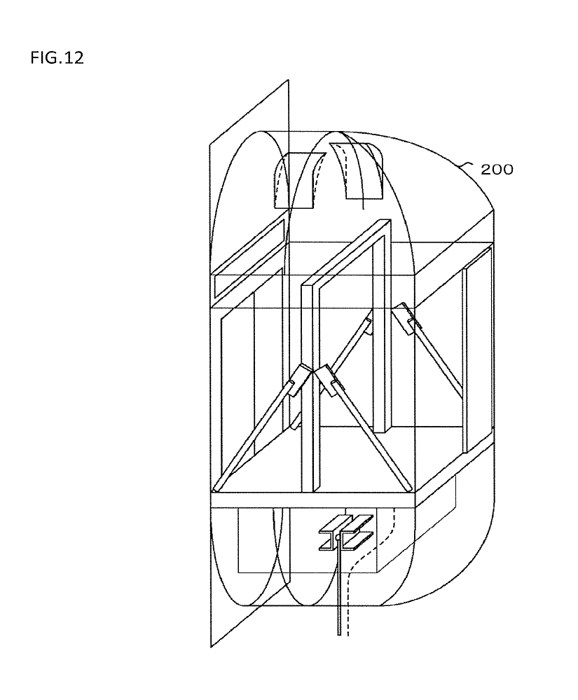

FIG. 12 is a perspective view for illustrating an air-regulating cover for an elevator according to a second embodiment of the present invention. An air-regulating cover 200 for an elevator is mounted to a top of a cage of an elevator. The air-regulating cover 200 for an elevator is formed of the fiber reinforced plastic 1. The other configurations are the same as those of the first embodiment.

As described above, the air-regulating cover 200 for an elevator according to the second embodiment of the present invention is formed of the fiber reinforced plastic 1, and hence can be produced at low cost.

It should be noted that, in each of the above-mentioned embodiments, an example of two laminated first fiber fabrics 21 and two laminated second fiber fabrics 41 has been described. However, the number of the first fiber fabrics 21 and the second fiber fabrics 41 is not limited to two. One first fiber fabric 21 and one second fiber fabric 41 may be used, and three or more laminated first fiber fabrics 21 and three or more laminated second fiber fabrics 41 may be used.

1. A fiber reinforced plastic comprising a plurality of layers formed to be integrated with each other using a same resin,
the fiber reinforced plastic comprising:
a first fiber reinforced plastic layer including a first fiber fabric and a resin for a first fiber fabric impregnated into the first fiber fabric;
a resin flow layer including a resin diffusion medium and the resin impregnated into the resin diffusion medium, the resin flow layer being laminated on the first fiber reinforced plastic layer;
a second fiber reinforced plastic layer including a second fiber fabric and a resin for a second fiber fabric impregnated into the second fiber fabric, the second fiber reinforced plastic layer being laminated on the resin flow layer so that the resin flow layer is arranged between the first fiber reinforced plastic layer and the second fiber reinforced plastic layer; and
an inorganic filler layer including an inorganic filler having a particle diameter of 20 μM or more and 50 μm or less and the resin, the inorganic filler layer being laminated on the second fiber reinforced plastic layer so that the second fiber reinforced plastic layer is arranged between the resin flow layer and the inorganic filler layer.

2. A fiber reinforced plastic according to claim 1, wherein the inorganic filler comprises aluminum hydroxide, antimony trioxide, or a mixture thereof.

3. An air-regulating cover for an elevator, comprising the fiber reinforced plastic of claim 1.

4. A method of producing a fiber reinforced plastic, comprising:
a forming step including laminating a first fiber fabric on a mold, laminating a resin diffusion medium on the first fiber fabric, and laminating a second fiber fabric on the resin diffusion medium;
an adhesion step of causing an inorganic filler to adhere to a silicone bag;
a bagging step of covering the first fiber fabric, the resin diffusion medium, and the second fiber fabric with the silicone bag and the mold so that the inorganic filler faces the second fiber fabric;
an impregnation step of impregnating the first fiber fabric and the second fiber fabric with a liquid resin through use of the resin diffusion medium as a resin flow passage;
a curing step of curing the resin after the impregnation step;
a demolding step of taking out, after the curing step, a fiber reinforced plastic body formed integrally with the resin from the mold and the silicone bag; and
a removal step of removing by polishing, after the demolding step, a portion, in which the inorganic filler projects, of a bag surface of the fiber reinforced plastic body facing the silicone bag.

5. An air-regulating cover for an elevator, comprising the fiber reinforced plastic of claim 2.
